(19) United States
(12) Patent Application Publication
(10) Pub. No.: US 2007/0149139 A1
(43) Pub. Date: Jun. 28, 2007

(54) Wireless Network System with Energy Management

(76) Inventor: Jean-Louis Gauvreau, La Prairie (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/566,272

(22) Filed: Dec. 4, 2006

Related U.S. Application Data
(63) Continuation-in-part of application No. 11/149,243, filed on Jun. 10, 2005.
(60) Provisional application No. 60/578,292, filed on Jun. 10, 2004.

(51) Int. Cl. H04B 7/00

(52) U.S. Cl. 455/69; 455/522

(57) ABSTRACT

A wireless network system with energy management is provided wherein the nodes of the networks can activate certain software and/or hardware functionalities upon the detection of an event. The network system generally comprises a plurality of wireless nodes adapted to communicate with each other, directly or through other nodes, via radio-frequency signals. Each node is also generally capable of measuring the received signal strength of the radio-frequency signals sent by its neighbouring nodes. By detecting a significant change in the received signal strength, which is generally due to a change in the generally immediate physical environment of the receiving node, the node can activate one or more of its hardware functionalities (e.g. sensors) and/or of its software functionalities (e.g. node discovery protocols). When no significant changes or variations of the received signal strength are detected, the functionalities are generally kept in dormancy by the node in order to reduce their energy consumption.

### CROSS-REFERENCE TO RELATED APPLICATIONS

The present patent application is a continuation-in-part of commonly assigned U.S. patent application Ser. No. 11/149,243, filed on Jun. 39, 2005, which is itself a Continuation-in-Part of commonly assigned U.S. Provisional Patent Application No. 360/578,292, filed on Jun. 310, 2004. Both applications are thereby incorporated herein by reference.

### FIELD OF THE INVENTION

The present invention generally relates to networks and more particularly, the present invention pertains to wireless networks and their associated wireless nodes.

### BACKGROUND OF THE INVENTION

Event and/or intrusion detection sensors can generally be categorized based on their application and underlying technology as shown in FIGS. 1 and 2.

Accordingly, depending on the kind of events which needs to be detected and on the environment in which the events are likely to occur, different combination of sensors can be deployed.

In the vast majority of settings, it is possible to connect the sensors to power lines in order to provide electrical power to the sensors. Also, when the sensors are networked via a wire network (e.g. Ethernet), the power can also be provided directly over the cables of the network. In both instances, the electrical power is generally unlimited.

However, in a certain number of settings such as, but not limited to, underground mines, battlefields, ad-hoc security perimeters and containers, it is generally difficult or even impossible to deploy power lines and/or network cables in order to provide electrical power to the sensors deployed therein. In these kinds of setting, wireless sensor networks are preferred but the sensor nodes comprised therein are generally battery powered. However, battery powered sensor nodes have a major drawback: their batteries have limited energy and therefore the nodes have a limited longevity.

Nevertheless, wireless sensor nodes must still combine two opposite requirements. On the one hand, in order to detect events, it is generally required that the sensors be active or awake most of the time. In other words, the nodes must generally be actively vigilant. On the other hand, keeping all the sensors of the nodes continuously active will drain the battery at an unacceptable rate and will overly limit the longevity of the node. A trade-off must therefore be found in order to reduce the energy consumption of the nodes in order to increase its longevity while at the same time, keeping the nodes vigilant enough to detect events.

One solution proposed by the prior art was to create a hierarchy in the sensors comprised in each node. In this system, a single primary sensor, i.e. a passive infra-red sensor, is kept active most of the time in order for the node to be at least passively vigilant and be able to detect events. However, if the primary sensor detects an event, it activates one or more of the other secondary sensors, which generally have a higher energy consumption, in order to confirm or infirm the reality of the event.

In another prior art solution, a radar is used as primary sensor when the other sensors are inactive.

Still, in the foregoing solutions, the primary sensor is generally always kept awake and therefore continuously consumes energy, thereby reducing the longevity of the node. Moreover, these sensors generally require a direct line-of-sight to detect events and, furthermore, they can be adversely affected by the shadowing phenomenon.

There is therefore a need for a wireless network system which will adequately combine the need for efficient energy consumption while keeping the system vigilant enough to detect events.

### OBJECTS OF THE INVENTION

Accordingly, an object of the present invention is to provide a wireless network system which generally reduces the energy consumption of the wireless nodes which are comprised in the network.

Another object of the present invention is to provide a wireless network system in which the radio-frequency transmission between the nodes is used both for communication and for preliminary event detection.

Another object of the present invention is to provide a wireless network system in which a node will activate one or more of its hardware and/or software functionalities only when an event is possibly detected.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

Accordingly, the present invention generally provides a wireless network system wherein one or more hardware and/or software functionalities comprised in each node, are generally kept in a dormant or inactive state until an event is likely detected.

The wireless network system of the present invention therefore generally comprises a plurality of wireless nodes, each wireless node of the network generally comprising a transceiver for transmitting and receiving radio-frequency signals to and from neighbouring wireless nodes and therefore for communicating therewith.

Furthermore, as noted above, each node generally comprises one or more functionalities which can be of hardware nature such as sensors, lights and speakers and/or of software nature such specific protocols. These functionalities are generally kept in dormancy in order to limit and reduce their energy consumption.

According to an important aspect of the present invention, each node further comprises a module, such as a power detector, for measuring the received signal strength of the radio-frequency signals it receives from its neighbouring nodes. Understandably, the power detector could be unitary and fully integrated with the transceiver whereby the demodulation and the power measurement of the signals would be done generally simultaneously.

In use, as the network is deployed, the nodes will generally automatically create a network such as an ad-hoc mesh network in order to be able to transmit information between themselves and also toward one of the nodes which is preferably also connected to a wide area network such as, but not limited to, the Internet, a cellular network or a satellite network. Understandably, other network topologies are also possible.

Therefore, at any given time, each node will generally be either receiving or sending radio-frequency signals from or to neighbouring nodes. The type of information transmitted between nodes can vary. For example, nodes can transmit routing information, node status information, etc.

Still, one of the important aspect of the present invention is that as each node receives radio-frequency signals, it will also generally measure the received signal strength of the signals in order to detect possible significant variations.

As used herein above and hereinafter, the generally equivalent expressions “significant change”, “significant variation”, “predetermined change” and “predetermined variation” must be construed as any variation or change in the received signal strength of the radio-frequency signals which should be considered as abnormal according to the condition in which the network has been deployed and/or according to the required level of vigilance of the network. Accordingly, a “significant change” in a noisy environment will generally be different from a “significant change” in a clear environment. Also, in an environment where the required level of vigilance of the network is high, the significance of the change might be lower than in an environment where the required level of vigilance is lower.

Moreover, it is to be understood that numerous causes can create a variation in the received signal strength of a radio-frequency signal and that accordingly, the “significant change” may have to be discriminate from “non-significant change”. Generally speaking, causes for “non-significant change” encompass, in a non-exhaustive list, background noise, third party communications (particularly but not exclusively in unregulated radio-frequency bands) and periodic movements or events (e.g. periodically passing trains).

It is thus left to the skilled addressee to determined, for each particular setting, what is an appropriate “significant change”.

Hence, if, during a communication between two nodes, a significant change or variation of the received signal strength occurs, then, the probabilities are high that someone or something has entered in the radio-frequency channel existing between the two communicating nodes. In that case, an event is likely occurring and specific actions are most preferably needed. Therefore, upon the occurrence of such a significant change in the received signal strength, the receiving node will awake or activate the necessary dormant functionalities in order to take appropriate actions.

In an exemplary setting, in the context of a wireless sensor network, the dormant functionalities may be the sensors themselves whereby upon detection of a significant change in the received signal strength of the radio-frequency signal, the receiving node may activate its sensors in order to further sense the environment for confirming or infirming the occurrence of the event.

In another exemplary setting, in the context of an ad-hoc wireless mesh network, the dormant functionality may be a node discovery protocol whereby upon detection of a significant change in the received signal strength of the radio-frequency signal, the receiving node may activate its node discovery protocol since a new node, not yet part of the network, may possibly have entered the communication range of the receiving node.

If the event is confirmed, appropriate action is initiated by the node and information about the event is generally sent to the neighbouring nodes. On the contrary, if the event is infirmed (e.g. a false alarm or no new node), the functionalities are put back into their dormant state in order to limit and reduce their energy consumption.

In an alternate embodiment of the present invention, a single node is used for the detection of events. In this alternate embodiment, the node preferably continuously emits radio-frequency signals. A portion of the radio-frequency signals sent by the node will be received by the same node due to the multiple reflections of the signals in the surrounding environment. The node, which is adapted to measure the strength of the received signals, verifies that there are no significant changes in the received signal strength. If a significant change is detected, the node concludes that a physical change is likely occurring in the radio-frequency channel defined around the node. In response to this possible physical change, the node wakes up or activates one or more of its functionalities in order to take appropriate actions.

In this embodiment, the information about the event is preferably stored in the node until it is retrieved later by external means. The event information could also be transmitted to a wide area network, via a modem, if the node is appropriately equipped to do so.

Therefore, the present invention generally relies on the detection of a significant variation of the received signal strength of the radio-frequency signals received by a node in order to trigger the activation of dormant functionalities. Still, since the nodes will generally be communicating with or without the occurrence of an event, the nodes will not consume additional energy between events in order to power at least one functionality. In fact, minimal vigilance is generally insured by the generally continuous monitoring of the received signal strength of the received radio-frequency signals which are used for communication between nodes.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 presents the technological categories of interior intrusion detection sensors.

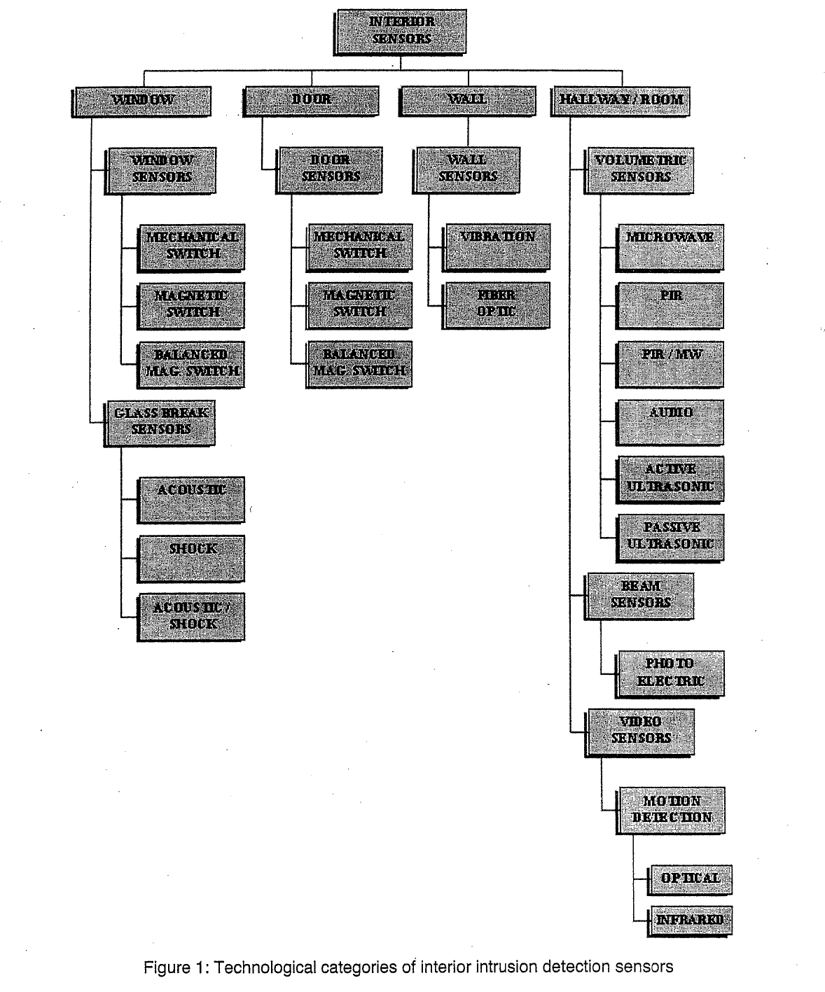

FIG. 2 presents the technological categories of exterior intrusion detection sensors.

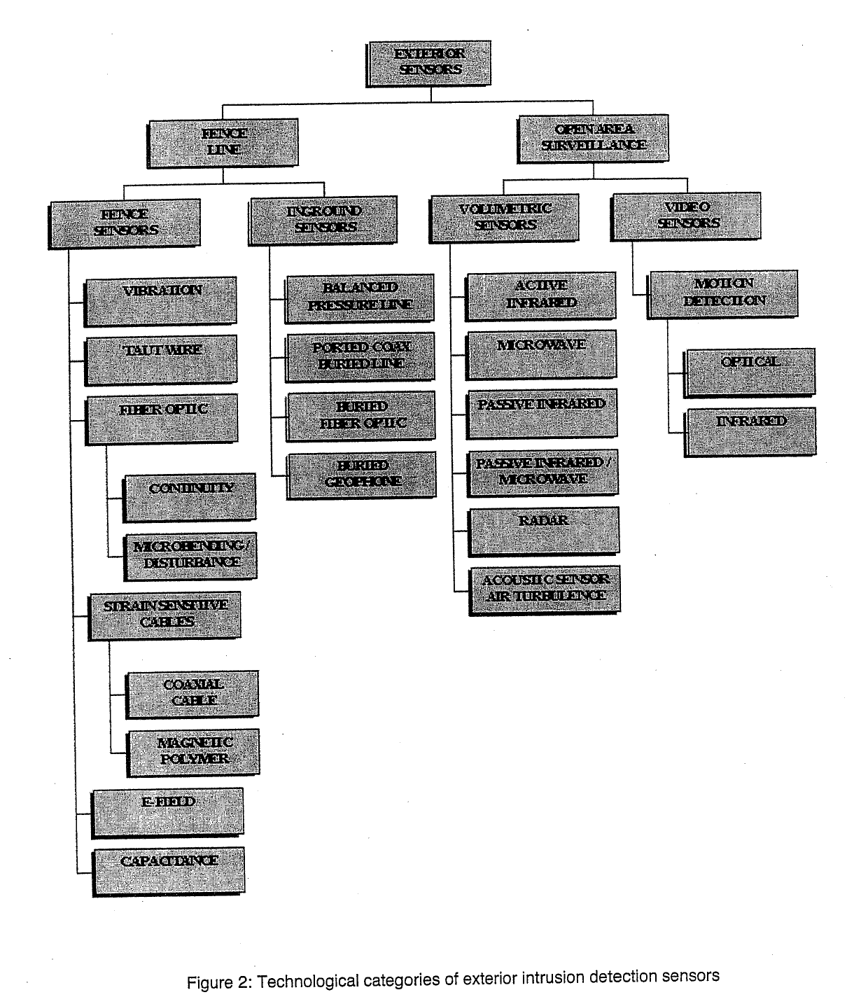

FIG. 3 is a schematic view of a wireless network according to one embodiment of the present invention.

FIG. 4 is a schematic view of a wireless device according to another embodiment of the present invention.

FIG. 5 is a schematic view of elements of the wireless node/device of FIGS. 3 and 4.

FIG. 6 presents sample plots of the received signal strength over time according to a deployment of the network of FIG. 3 in an office setting;

FIG. 7 presents sample plots of the received signal strength over time according to a deployment of the network of FIG. 3 in a freight container setting with both wireless nodes inside the container;

FIG. 8 presents sample plots of the received signal strength over time according to a deployment of the network of FIG. 3 in an freight container setting with one wireless node inside the container and one outside;

### DETAILED DESCRIPTION OF THE PREFERRED EMBODIMENT

A novel wireless network system which is adapted to manage the energy consumption of its nodes will be described hereinafter. Although the invention is described in terms of specific illustrative embodiments, it is to be understood that the embodiments described herein are by way of example only and that the scope of the invention is not intended to be limited thereby.

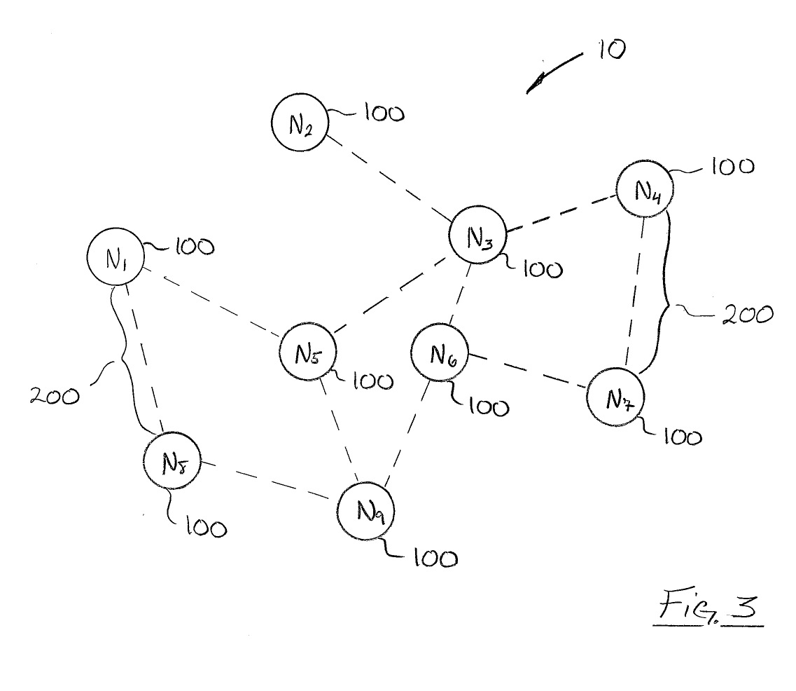

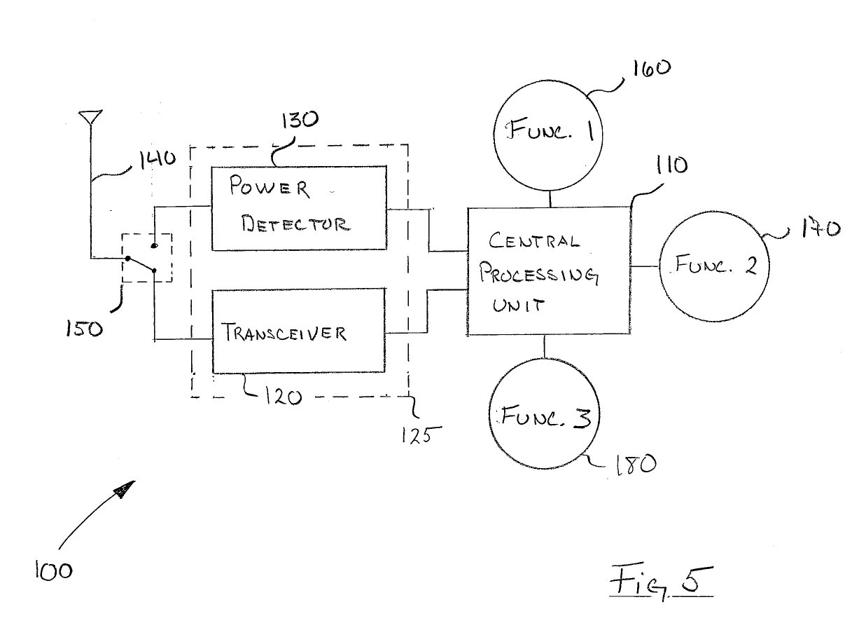

Referring first to FIG. 3, a first embodiment of the present invention is shown. The wireless network 10 of the present invention generally comprises a plurality of wireless nodes 100 which are adapted to communicate with each other via radio-frequency signals. Accordingly, a radio-frequency channel 200, schematically shown in FIG. 3 in dashed lines, is defined between each pair of nodes 100 which are within range of each other. Understandably, the actual radio-frequency channel 200 will depend on the location of the nodes 100, the radiating pattern of the antennas 140 (see FIG. 5) thereof and the environment in which the network 10 is deployed.

Referring now to FIG. 5, each node 100 of the network 10 is substantially similar to the others and comprises a central processing unit 110 which processes all the information sent and/or received by the nodes. The node 100 also generally includes data storage modules (not shown for clarity). The node 100 also comprises a transceiver 120 which is adapted to send and received radio-frequency signals to and from other neighbouring nodes 100. Understandably, the transceiver 120 is further connected to an antenna 140 via switching means such as a switch 150 or any other similar physical or electronic switching component. Also connected to the antenna 140, via the switch 150, is a power detector 130 which is adapted to measure the power level or strength of the received radio-frequency signals. The power detector 130 is also connected to the central processing unit 110.

Alternatively, the transceiver 120 and the power detector 130 could be unitary and fully integrated into a single component 125 whereby the single component 125 would be able to simultaneously modulate/demodulate and measure the power level of radio-frequency signals. Understandably, in this alternative embodiment, the switching means 150 would not be necessary.

Finally, the node 100 also comprises at least one and preferably a plurality of functionalities 160, 170 and 180, all of which are connected to and/or operable by the central processing unit 110. Though three functionalities are shown, the node 100 could understandably comprise more or less than three functionalities.

Furthermore, as mentioned above, the functionalities could be of hardware nature such as sensors, lights, speakers, electro mechanical devices, etc. or of software nature such as node discovery protocols, object tracking protocol, etc. Combination of both hardware and software functionalities are also possible and within the scope of the invention.

In any case, for the sake of simplicity and exemplarity, the remaining of the present description will be made according to embodiments wherein the functionalities are of hardware nature and more particularly, are sensors.

Accordingly, the kind of sensors used in each node 100 could vary according to the type of environment in which the network 10 is deployed and according to the type of events which are likely to occur. Hence, the sensors could be chosen among the following non-exhaustive list: passive or active infra-red, magnetic detection, microphone, geophone, etc.

As the nodes 100 of the network 10 communicate with each other, radio-frequency signals are sent and received by different nodes 100. According to the present invention, as the radio-frequency signals are received by a node 100, a portion thereof is sent to the transceiver 120 for demodulation and decoding and another portion thereof is sent to the power detector 130 in order to measure the received signal strength of the received signals.

Understandably, should the transceiver 120 and the power detector be unitary and fully integrated into a single component 125, the demodulation and the power measurement of the received radio-frequency signals would be done generally simultaneously by the component 125.

If, during the reception of radio-frequency signals, the node 100, via the power detector 130 and the central processing unit 110, detects a significant change or variation therein, the central processing unit 110 will conclude that someone or something is affecting the radio-frequency channel 200 and therefore that an event is likely to be occurring. Thereafter, the central processing unit 110 will wake up and activate the sensors 160, 170 and 180, simultaneously or according to a predetermined hierarchy. Once activated, the sensor or sensors will sense the environment in order to confirm the occurrence of the event or to infirm it.

According to the preferred embodiment, the detection of a significant change in the received signal strength is effected using the following algorithm.

First, the node 100 stores the latest received signal strength measurement and also, if applicable, the frequency on which the signal was transmitted. Then, the node 100 compares the latest received signal strength measurement with the previously received signal strength measurement for the same frequency. The absolute difference between both measurements is stored in a buffer of size N which is preferably common for all frequencies if multiple frequencies are used in the network 10. Then, a moving average of the N latest differences is computed whereby if the moving average goes beyond a predetermined value, the node 100 concludes that an event is occurring or has recently occurred.

Understandably, the exact value of the threshold value is chosen by the skilled person deploying the network 10 and is generally though not exclusively based on several parameters such as the level of background noise, the presence of third party communications and the desired level of sensibility.

Furthermore, the algorithm could also be adapted to filter out erroneous measurements such as measurements which are abnormally below the average received signal strength measurements or measurements coming from frequencies having an abnormal volatility in their received signal strength measurements.

If the event is confirmed, the node 100 which has first detected the event will preferably send event detection information to neighbouring nodes 100 which can also activate their sensors for further detection prior to relaying the information toward a special node 100 which is preferably connected to a wide area network via an appropriate modem (not shown). Without being limitative, the wide area network could be the Internet, a cellular network or a satellite network.

On the other hand, if the event is infirmed, the central processing unit 110 will conclude that it was a false alarm and will instruct the sensors to return to their dormant state until another significant change in the received signal strength is detected.

It is to be understood that since the present invention is preferably embodied in a wireless network, the intelligence of the network can be distributed among the nodes 100. For example, if a node 100 detects an event coming from a particular direction, the node 100 can relay this information to neighbouring nodes 100 in that particular area in order to increase the vigilance of the network 10 in that particular area.

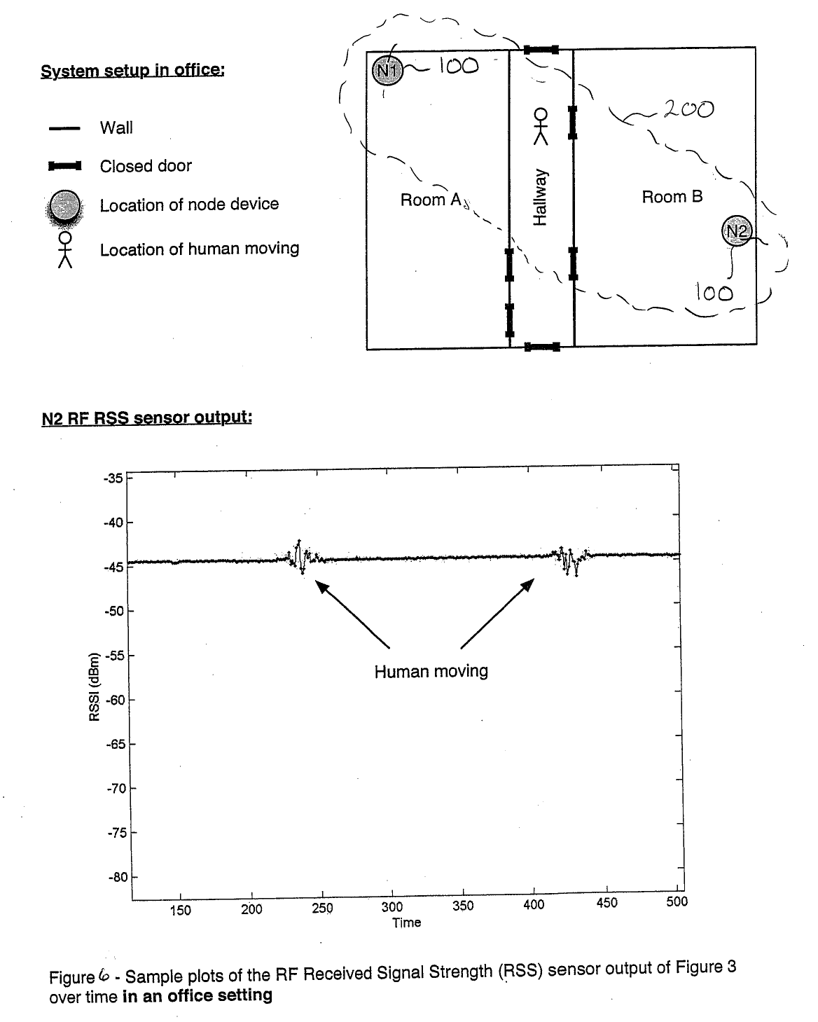

Non-limitative examples of deployments of the network 10 of the present invention are shown in FIGS. 6 to 8. In FIG. 6, the network comprises at least two nodes 100 which are deployed in two rooms separated by a hallway. As shown in the received signal strength output graph, if, for example, a person travels down the hallway, its entry into the radio-frequency channel 200 defined between the two nodes 100 will generate a variation in the received signal strength and the receiving node 100 will activate its sensors, for example, a passive infra-red sensor and a microphone, in order to confirm the event, i.e. the passage of the person.

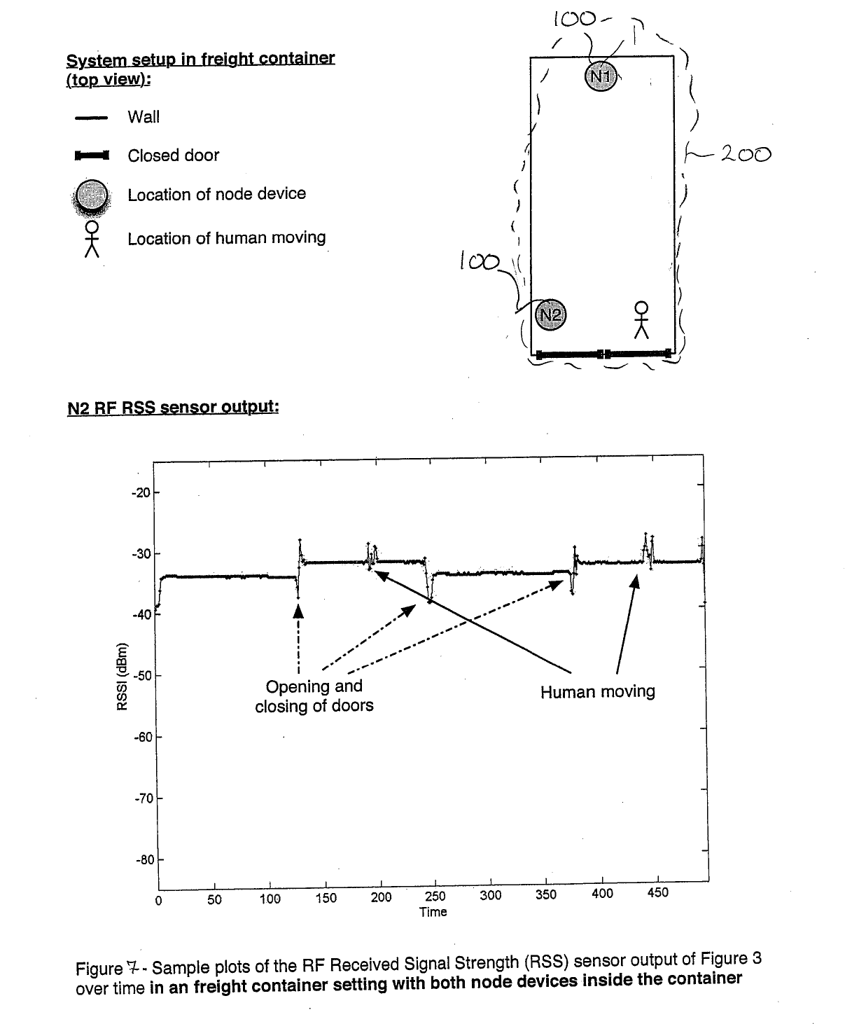

In FIG. 7, the network 10 is deployed inside a container. In that setting, any movement occurring in the container will affect the radio-frequency channel 200 and therefore will cause a variation in the received signal strength. Upon the occurrence of the variation, the receiving node 100 will activate its sensors in order to confirm if an event is occurring or if it was a false alarm.

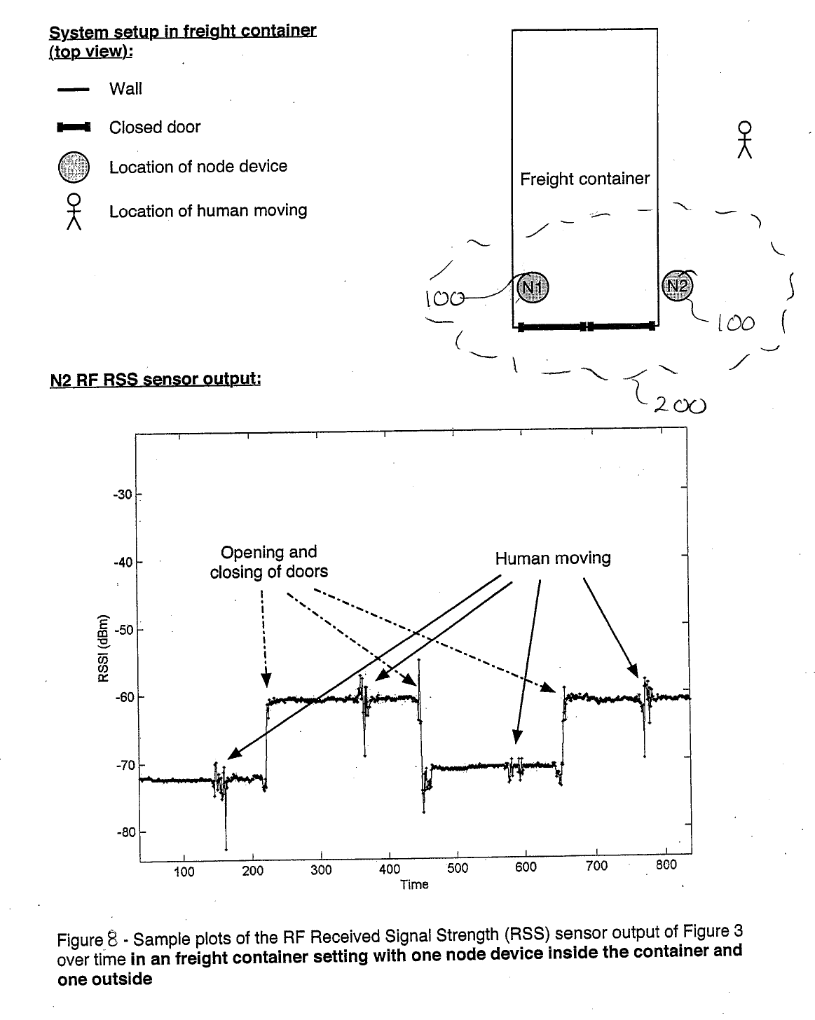

In FIG. 8, which is similar to FIG. 7, the nodes 100 of the network 10 are installed inside and outside the container. In that alternate setting, any events such as the opening or closing of the container's doors or the approaching of a person or vehicle will affect the radio-frequency channel 200 and therefore will cause a variation in the received signal strength. Upon the detection of such a significant variation, the receiving node 100 will activate its sensors in order to further sense the environment to thereby confirm or infirm the occurrence of the event.

Understandably, the number of nodes 100 in the network 10 can vary depending upon the desired area of coverage and/or on the particular setting in which the network will be deployed. Hence, in an open space such as on a battlefield, the network 10 could comprise tens and even hundreds of nodes 100 whereas in an office setting, the number of nodes could be more limited.

Yet, since the nodes 100 are adapted to communicate with each others and to define a network 10, the coverage of an area can be increased by increasing the number of nodes 100 in the network 10.

For example, in FIG. 6, it would be possible to add one or more nodes 100 in order to increase the coverage of the area and/or to cover more rooms. Also, in FIGS. 7 and 8, should two or more containers equipped with nodes 100 be placed near one another, the nodes 100 of one container could communicate with the nodes 100 of an adjacent container, thereby increasing the coverage area to the cluster of containers.

As mentioned above, the functionalities activated upon the detection of an event can also be of software nature. Therefore, in the preceding example, as a new container is placed near first one, the nodes 100 of the first container will detect the event, i.e. the arrival of the new container nearby. Still, further to activating its sensors to confirm the event, one of the node 100 could also activate its node discovery protocol, kept inactive prior to the detection of the event, in order to possibly detect new nodes 100 which might be present in the new container and to thereby possibly enlarge the network 100.

By using the received signal strength as a mean to determine if an event is occurring and therefore to determine if further actions are required, the nodes 100 of the network 10 of the present invention generally do not use additional power, as in the prior art, to keep the nodes 100 vigilant enough to detect possible events.

Indeed, each node 100 monitor the received power of the received radio-frequency signals which are transmitted with or without the occurrence of an event since the nodes 100 of the network 10 will be generally always be communicating.

It is only when a significant change or variation occurs in the received signal strength that a node 100 will activate its additional functionalities in order to confirm or infirm the event or to take appropriate actions. Otherwise, the functionalities are generally kept in dormancy or even inactive in order to reduce their energy consumption.

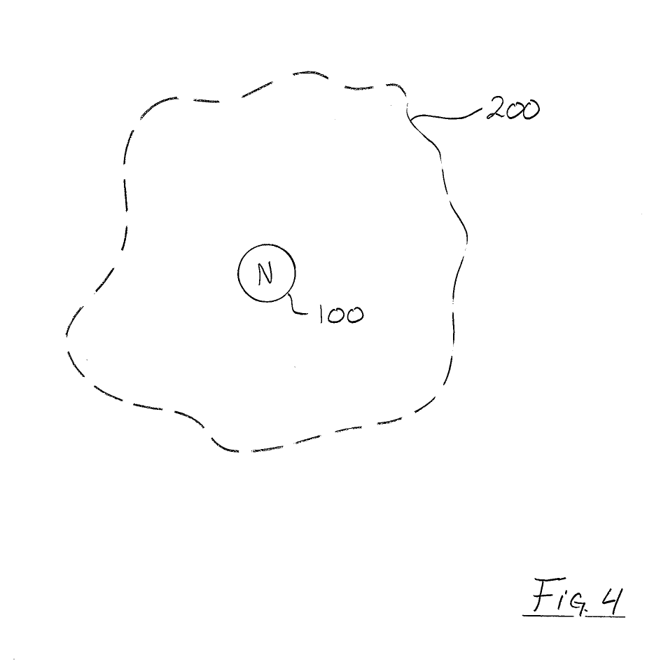

In an alternative embodiment of the present invention shown in FIG. 4, a node 100 is used as a stand alone device. In that embodiment, the node 100 emits radio-frequency signals which are partially reflected back by structural elements located in the surroundings of the node 100.

As for the first embodiment, the node 100 in this second embodiment will preferably continuously monitor the power level or strength of the received radio-frequency signals. If a significant change appears in the received signal strength, the central processing unit 110 will conclude that an event is occurring or has recently occurred in the surroundings of the node 100 since the reflection pattern of the signals has significantly changed.

In response, the central processing unit 110 will wake up and activate the dormant functionalities, simultaneously or following a hierarchy, in order for the functionalities to further sense the immediate environment or to take appropriate actions.

In this embodiment, unless the node 100 has access to a wide area network via a modem, the node will store the event information in its memory for later retrieval.

While illustrative and presently preferred embodiments of the invention have been described in detail herein above, it is to be understood that the inventive concepts may be otherwise variously embodied and employed and that the appended claims are intended to be construed to include such variations except insofar as limited by the prior art.

1. A wireless network system comprising a plurality of nodes, each node comprising:
a. processing means;
b. transceiving means in electronic communication with said processing means and adapted to transmit and receive radio-frequency signals;
c. power measuring means in electronic communication with said processing means and adapted to measure the received signal strength of said radio-frequency signals;
d. an antenna in electronic communication with said transceiving means and said power measuring means;
e. at least one additional functionality operable by said processing means;
wherein said nodes are adapted to transmit and received said radio-frequency signals and wherein when one of said nodes detects at least a predetermined change in said received signal strength, said processing means of said node activates said at least one additional functionality and wherein when one of said nodes does not detect said predetermined change in said received signal strength, said processing means of said node keeps said at least one additional functionality inactive.

2. A wireless network system as claimed in claim 1, wherein said at least one additional functionality is an electronic device.

3. A wireless network system as claimed in claim 1, wherein said at least one additional functionality is a sensor.

4. A wireless network system as claimed in claim 1, wherein said at least one additional functionality is a computer software.

5. A wireless network system as claimed in claim 1, wherein said at least one additional functionality is a software protocol.

6. A wireless device comprising:
a. processing means;
b. transceiving means in electronic communication with said processing means and adapted to transmit and receive radio-frequency signals;
c. power measuring means in electronic communication with said processing means and adapted to measure the received signal strength of said radio-frequency signals;
d. an antenna in electronic communication with said transceiving means and said power measuring means;
e. a t least one additional functionality operable by said processing means;
wherein said device is adapted to transmit and received said radio-frequency signals and wherein when said device detects at least a predetermined change in said received signal strength, said processing means of said device activates said at least one additional functionality and wherein when said device does not detect said predetermined change in said received signal strength, said processing means of said device keeps said at least one additional functionality inactive.

7. A wireless network system as claimed in claim 6, wherein said at least one additional functionality is an electronic device.

8. A wireless network system as claimed in claim 6, wherein said at least one additional functionality is a sensor.

9. A wireless network system as claimed in claim 6, wherein said at least one additional functionality is a computer software.

10. A wireless network system as claimed in claim 6, wherein said at least one additional functionality is a software protocol.
